(19) United States
(12) Patent Application Publication
(10) Pub. No.: US 2010/0248081 A1
(43) Pub. Date: Sep. 30, 2010

(54) LIQUID TANK AND FUEL CELL

(75) Inventor: Jusuke SHIMURA, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: SONY CORPORATION, Tokyo (JP)

(21) Appl. No.: 12/729,833

(22) Filed: Mar. 23, 2010

(30) Foreign Application Priority Data
Mar. 31, 2009 (JP) 2009-085736

(51) Int. Cl. H01M 8/04

(52) U.S. Cl. 429/513

(57) ABSTRACT

The present invention provides a liquid tank capable of maintaining inner pressure constant even in a state where it is inclined at any angle and a fuel cell using the same. A liquid tank includes: an outside casing provided with one gas inlet/outlet port; and a liquid-repellent structure provided on the inside of the outside casing, connecting two or more vertexes, sides, or faces of the outside casing and the gas inlet/outlet port, and made of a liquid-repellent material having a void through which gas passes.

### BACKGROUND OF THE INVENTION

1. Field of the Invention

The present invention relates to a liquid tank for storing liquid fuel of a fuel cell or the like and to a fuel cell having the same.

2. Description of the Related Art

A fuel cell system using a liquid fuel such as methanol and a hydrogen generation aid such as water usually has therein a tank that stores liquid. In such a liquid tank, usually, liquid to be stored and gas such as air coexist. Further, a method of supplying air into a tank and pushing liquid fuel by the pressure of air is proposed (refer to, for example, Japanese Unexamined Patent Application Publication No. 2005-30699).

### SUMMARY OF THE INVENTION

However, in such a conventional liquid tank, when gas in the tank is warmed by heating, the air expands and the inner pressure rises. It is feared that the liquid blows out abnormally or the tank is broken, and there is room for improvement.

To address the drawback, for example, a method of providing a gas inlet/outlet port as an air hole in a liquid tank is considered. In a stationary fuel cell system, the posture of the liquid tank does not change, so that it is sufficient to provide one gas outlet/inlet port in the top face of the liquid tank. On the other hand, a fuel cell system to be mounted on a portable device is requested to maintain the inner pressure constant even in a state where a liquid tank is inclined at any angle by making gas escape to the outside while preventing the liquid from being leaked from the gas inlet/outlet port.

Japanese Patent No. 2,716,883 discloses an ink storing tank for an ink jet printer in which air holes are provided at corners of the tank and, by making the inner face of the air holes water-repellent, ink leakage from the air holes positioned below the liquid level may be suppressed. Since most of inks for ink jet are aqueous solution and aqueous dispersion, even if the air holes are directly open to the atmosphere like in the Japanese Patent Application Publication No. 2005-30699, harmful materials are hardly leaked to the outside. In the case of a fuel cell, however, since vaporized methanol is mixed in the gas in the tank, there is a problem that if a configuration similar to that of the Japanese Patent Application Publication No. 2005-30699 is used, methanol is leaked to the atmosphere.

It is desirable to provide a liquid tank capable of maintaining inner pressure constant even in a state where it is inclined at any angle, and a fuel cell using the same.

A first liquid tank of an embodiment of the invention includes:

(A) an outside casing provided with one gas inlet/outlet port; and

(B) a liquid-repellent structure provided on the inside of the outside casing, connecting two or more vertexes, sides, or faces of the outside casing and the gas inlet/outlet port, and made of a liquid-repellent material having a void through which gas passes.

A second liquid tank of an embodiment of the invention includes a liquid-repellent casing whose all of faces are made of a liquid-repellent material having a void through which gas passes.

The term “liquid repellency” denotes that the cosine of the contact angle θ to a liquid is negative. On the contrary, the term “lyophile” denotes that the cosine of the contact angle θ to a liquid is positive.

First and second fuel cells of embodiments of the present invention have a fuel cell body and a fuel cartridge having a liquid tank. As the liquid tank, the first and second liquid tanks as embodiments of the invention are used.

According to the first liquid tank of to an embodiment of the invention, two or more vertexes, sides, or faces of the outside casing and the gas inlet/outlet port are connected by the liquid-repellent structure. The liquid-repellent structure is made of the liquid-repellent material having a void through which gas passes. Consequently, liquid does not enter the liquid-repellent structure due to capillary force, and the inside of the structure is always filled with gas. At least one vertex of the outside casing is always in contact with the gas even when the outside casing is inclined at any angle. Therefore, gas enters/leaves from the vertex which is in contact with the gas, a side including the vertex, or a part of a face including the vertex, through the inside of the liquid-repellent structure, and the inner pressure is maintained constant.

According to the second liquid tank of an embodiment of the invention, all of faces of the liquid-repellent casing are made of a liquid-repellent material having a void through which gas passes. Liquid does not enter the liquid-repellent material due to capillary force, and the inside of the material is always filled with gas. At least one vertex of the liquid-repellent casing is always in contact with the gas even when the liquid-repellent casing is inclined at any angle. Therefore, gas enters/leaves from the vertex which is in contact with the gas, through the inside of the liquid-repellent material, and the inner pressure is maintained constant.

Since the first and second fuel cells of embodiments of the invention have the first and second liquid tanks of embodiments of the invention, even in a state where the liquid tank is inclined at any angle, the inner pressure is maintained constant. Thus, abnormal ejection of the liquid and breakage of the liquid tank is suppressed, and safety improves.

According to the first liquid tank of an embodiment of the invention, the liquid-repellent structure is made of the liquid-repellent material having a void through which gas passes, and two or more vertexes, sides, or faces of the outside casing and the gas inlet/outlet port are connected by the liquid-repellent structure. Therefore, even when the outside casing is inclined at any angle, the inner pressure is maintained constant.

According to the second liquid tank of an embodiment of the invention, all of faces of the liquid-repellent casing are made of a liquid-repellent material having a void through which gas passes. Therefore, even when the liquid-repellent casing is inclined at any angle, the inner pressure is maintained constant.

Since the first and second fuel cells of embodiments of the invention have the first and second liquid tanks of embodiments of the invention, the inner pressure is maintained constant regardless of the posture of the liquid tanks. Particularly, the invention is suitable to a fuel cell to be mounted on a portable electronic device, and safety of the device improves.

Other and further objects, features and advantages of the invention will appear more fully from the following description.

### BRIEF DESCRIPTION OF THE DRAWINGS

FIG. 1 is a cross section illustrating a configuration of a liquid tank according to a first embodiment of the present invention.

FIG. 2 is a perspective view illustrating the appearance of the liquid tank shown in FIG. 1.

FIG. 3 is a diagram for explaining the operation of a liquid-repellent material illustrated in FIG. 1.

FIG. 4 is a diagram for explaining a state where a liquid-repellent casing illustrated in FIG. 1 is inclined.

FIG. 5 is a cross section illustrating a configuration of a liquid tank according to a second embodiment of the invention.

FIG. 6 is a cross section illustrating a configuration of a liquid tank according to a third embodiment of the invention.

FIGS. 7A to 7D are diagrams for explaining the operation of a capillary gradient material illustrated in FIG. 6.

FIG. 8 is a cross section illustrating a configuration of a liquid tank according to a fourth embodiment of the invention.

FIG. 9 is a perspective view illustrating the appearance of the liquid tank shown in FIG. 8.

FIG. 10 is a perspective view illustrating an example of a water-repellent structure shown in FIG. 8.

FIG. 11 is a perspective view illustrating another example of the water-repellent structure shown in FIG. 8.

FIG. 12 is a perspective view illustrating further another example of the water-repellent structure shown in FIG. 8.

FIG. 13 is a cross section illustrating a schematic configuration of a fuel cell according to a fifth embodiment of the invention.

FIG. 14 is a plan view illustrating a configuration of the fuel cell body shown in FIG. 13 viewed from the side of a cathode-side plate member.

FIG. 15 is a perspective view illustrating the main part of the fuel cell shown in FIG. 13.

FIG. 16 is a perspective view illustrating an example of the internal structure of the liquid tank shown in FIG. 13.

FIG. 17 is a cross section illustrating a repellent structure shown in FIG. 16.

FIG. 18 is a perspective view illustrating an example of arrangement of a repellent structure and a lyophile structure.

FIG. 19 is a perspective view illustrating another example of arrangement of a repellent structure and a lyophile structure.

FIG. 20 is a perspective view illustrating further another example of arrangement of a repellent structure and a lyophile structure.

FIG. 21 is an exploded perspective view illustrating an example of the lyophile structure illustrated in FIG. 17.

FIG. 22 is a perspective view for explaining the operation of the lyophile structure illustrated in FIG. 16.

FIG. 23 is a cross section illustrating the configuration of a liquid tank according to a sixth embodiment of the invention.

FIG. 24 is a cross section illustrating the configuration of a liquid tank according to a seventh embodiment of the invention.

FIG. 25 is a diagram illustrating the configuration of a fuel cell according to an eighth embodiment of the invention.

### DETAILED DESCRIPTION OF THE PREFERRED EMBODIMENTS

Embodiments of the present invention will be described in detail below with reference to the drawings. The description will be given in the following order.

1. first embodiment (liquid tank; water-repellent casing)

2. second embodiment (liquid tank; the outer face of a water-repellent casing is covered with an outer casing)

3. third embodiment (liquid tank; a water-repellent casing is formed by a capillary gradient material)

4. fourth embodiment (liquid tank; a water-repellent structure is provided in an outer casing)

5. fifth embodiment (liquid tank of fuel cell; a water-repellent structure and a lyophile structure are provided in an outer casing)

6. sixth embodiment (liquid tank of fuel cell; a lyophile structure is provided in a water-repellent structure)

7. seventh embodiment (liquid tank of fuel cell; a lyophile structure is provided in a water-repellent structure and the outer face of the water-repellent structure is covered with an outer casing)

8. eighth embodiment (exhaust from a liquid tank is not released to atmosphere)

### First Embodiment

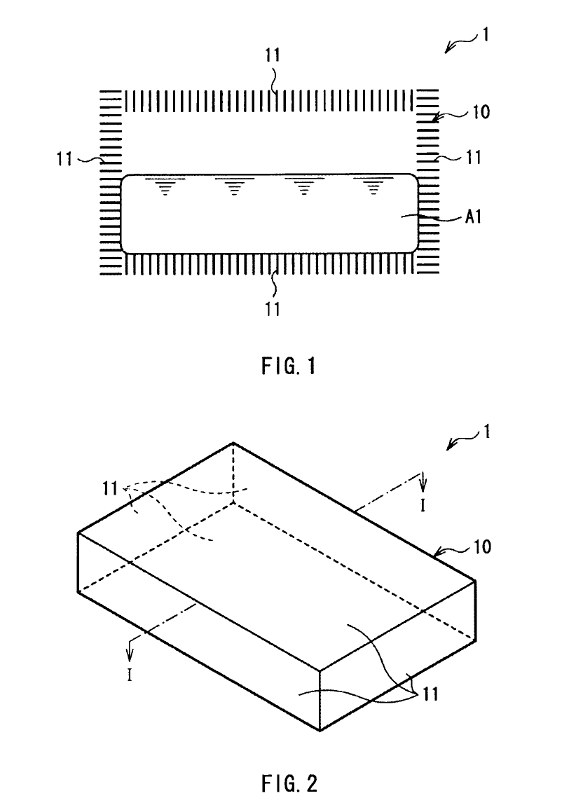

FIG. 1 illustrates a sectional configuration of a liquid tank according to a first embodiment of the present invention. FIG. 2 expresses the appearance of the liquid tank illustrated in FIG. 1. A liquid tank 1 is used, for example, as a fuel tank of a fuel cell and has a liquid-repellent casing 10.

The liquid-repellent casing 10 has, for example, a rectangular parallelepiped shape. All of six faces of the liquid-repellent casing 10 are made of a liquid-repellent material 11 having pores through which gas passes. Consequently, in the liquid tank 1, the inner pressure may be maintained constant even in a state where the liquid-repellent casing 10 is inclined at any angle.

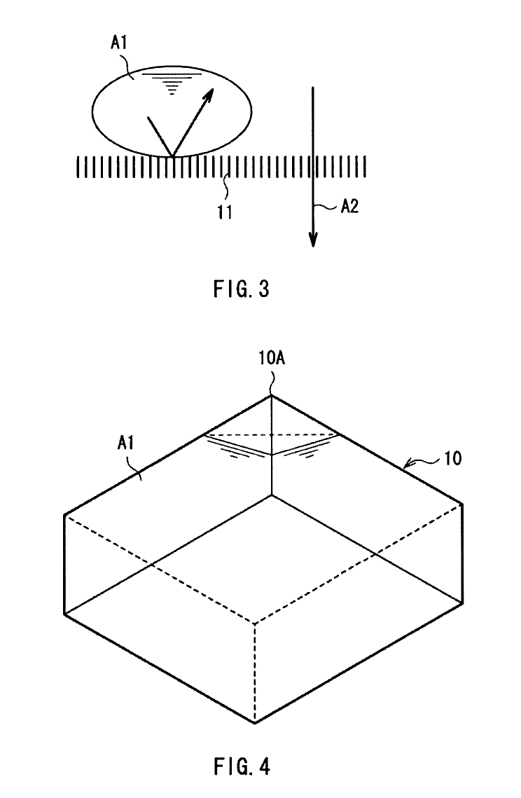

The liquid-repellent material 11 has low wettability to liquid, that is, cosine of a contact angle θ of the liquid is negative. Therefore, since liquid is not entered by capillary force, the inside of the liquid-repellent material 11 is always filled with gas. That is, as illustrated in FIG. 3, the liquid-repellent material 11 does not pass a liquid A1 but passes air A2. Therefore, the liquid-repellent casing 10 whose faces are all made of the liquid-repellent material 11 may freely pass air without leaking the liquid A1 on the inside.

Such a liquid-repellent material 11 is made of, for example, at least one of a porous material, a sponge material, a foam material, a fiber material, and a tubule bundle. Concretely, a suitable material is obtained by performing water repelling process using a resin having a perfluoroalkyl group on natural fiber, animal hair fiber, polyacetal, acrylic resin, polyester resin such as polyethylene terephthalate, polyamide resin such as nylon, polyolefin-based resin such as polyurethane, polypropylene, or polyethylene, polyvinyl, polycarbonate, polyether resin, polyphenylene resin, polylactic resin, foam metal, foam oxide, zeolite, or biscuit-fired pottery. The liquid-repellent material 11 may be a material obtained by performing the above-described water repelling process on a foam (foam material), a felt, a felt sintered body, or particle sintered body made of one of the materials or a combination of two or more of them. A concrete material is obtained by, for example, performing the water repelling process on a porous metal material made of nickel (Ni) (such as “Celmet (trade name)” manufactured by Sumitomo Electric Toyama Co., Ltd.) by using fluorine resin (such as “Fluoro Surf (registered trademark)” manufactured by Fluoro Technology Co., Ltd.). The porous metal material is obtained by forming a nickel film on the surface of a foam resin by electroplating, and has a three-dimensional net-like skeleton structure.

The liquid tank 1 is manufactured, for example, as follows.

First, for example, the above-described porous metal material made of nickel (Ni) (such as “Celmet (trademark)” manufactured by Sumitomo Electric Toyama Co., Ltd.) is prepared. The porous metal material is processed with a “primer coat dedicated to Fluoro Surf (registered trademark)” made of a silane-based compound manufactured by Fluoro Technology Co., Ltd. Subsequently, by performing coating process on the processed porous metal material with a fluorine resin (for example, “Fluoro Surf (registered trademark)” manufactured by Fluoro Technology Co., Ltd.), the liquid-repellent material 11 is formed. Subsequently, by the liquid-repellent material 11, all of the faces of the liquid-repellent casing 10 are formed. In such a manner, the liquid tank 1 illustrated in FIGS. 1 and 2 is completed.

When the liquid-repellent material 11 was actually manufactured in a manner similar to the above-described manufacturing method and water droplets were put on the obtained liquid-repellent material 11, the liquid-repellent material 11 completely repelled water and no water penetrates the inside. When the liquid-repellent material 11 was dropped in water, the liquid-repellent material 11 floated on water. The specific gravity of nickel is 8.9 g/cc which much heavier than that (1.0 g/cc) of water, so that the material is supposed to sink. Since the liquid-repellent material 11 perfectly repels water and air is stored on the inside, it is considered that the liquid-repellent material 11 floats due to its buoyancy. Further, when the liquid-repellent material 11 is dropped in methanol aqueous solution of 80 vol %, the liquid-repellent material 11 floats in a manner similar to the case of water. It is therefore understood that when all of the faces of the liquid-repellent casing 10 are made of the liquid-repellent material 11, the liquid A1 is contained without leakage.

In the liquid tank 1, all of the faces of the liquid-repellent casing 10 are made of the liquid-repellent material 11 having voids through which gas passes. Liquid is not entered the liquid-repellent material 11 due to the capillary force, and the inside of the material is always filled with gas. At least one vertex of the liquid-repellent casing 10 is always in contact with the gas even when the liquid-repellent casing 10 is inclined at any angle as illustrated in FIG. 4. Therefore, gas enters/leaves from the vertex 10A which is in contact with the gas through the inside of the liquid-repellent material 11, and the inner pressure of the liquid-repellent casing 10 is maintained constant.

As described above, in the embodiment, all of the faces of the liquid-repellent casing 10 are made of the liquid-repellent material 11 having voids through which gas passes, so that the inner pressure may be maintained constant even in a state where the liquid-repellent casing 10 is inclined at any angle.

Although the case where the liquid-repellent casing 10 has a rectangular parallelepiped shape has been described above in the foregoing embodiment, obviously, the shape of the liquid-repellent casing 10 is not limited.

### Second Embodiment

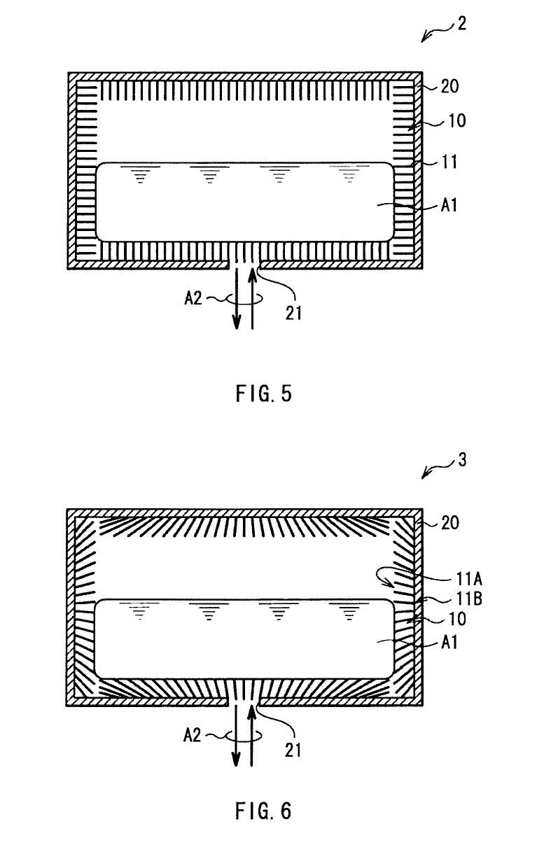

FIG. 5 illustrates a sectional configuration of a liquid tank 2 according to a second embodiment of the invention. The liquid tank 2 is constructed in a manner similar to the liquid tank 1 described in the first embodiment except that an outside casing 20 covering the outer faces of the liquid-repellent casing 10 is provided. Therefore, the same reference numerals are designated to corresponding components.

The liquid-repellent casing 10 and the liquid-repellent material 11 are constructed in a manner similar to the first embodiment.

The outside casing 20 is provided to improve impact resistance of the liquid tank 2. When strong vibration, impact, or the like is applied to the liquid A1 on the inside (that is, when large acceleration is applied), a large force is applied to the surface of the liquid-repellent material 11 (the force is proportional to the acceleration). When the force exceeds the capillary force, the liquid A1 enters the liquid-repellent material 11 and further reaches the back side of the liquid-repellent material 11, and a so-called “leakage” occurs. Also in the case where the outside casing 20 is provided, the liquid A1 is not prevented from entering the inside but may be prevented from being leaked to the outside.

The outside casing 20 also has the function of reducing vaporization rate of the liquid A1. In the case where the outside casing 20 is not provided, the inner gas and the outer gas may be easily replaced with each other. Under such circumstances, when a harmful substance, for example, methanol is included in the liquid A1, methanol is easily vaporized and diffused into air. By providing the outside casing 20, the vaporization rate of methanol is delayed.

The outside casing 20 has a gas inlet/outlet port 21. The position of the gas inlet/outlet port 21 may be selected according to the configuration of a device side to which the liquid tank 2 is attached and may be just below the liquid A1. The number and dimensions of gas inlet/outlet ports 21 are also not limited. However, one gas inlet/outlet port 21 is sufficient. Unlike a usual casing, it is unnecessary to provide air holes at the corners of the outside casing 20. Through one gas inlet/outlet port 21, gas is allowed to go out/in. Therefore, even in the case of storing the liquid A1 containing a harmful substance, management of the gas exhausted from the gas inlet/outlet port 21 is facilitated, the possibility that the harmful substance is leaked to the atmosphere is reduced, and safety improved. The outside casing 20 is also provided with a liquid inlet/outlet port (not shown) for the liquid A1.

The liquid tank 2 may be manufactured, for example, as follows.

First, in a manner similar to the first embodiment, the liquid-repellent material 11 is formed and all of the faces of the liquid-repellent casing 10 is made of the liquid-repellent material 11. Next, by the above-described material, the outside casing 20 having the gas inlet/outlet port 21 is formed. With the outside casing 20, the outer faces of the liquid-repellent casing 10 are covered. In such a manner, the liquid tank 2 is completed.

In the liquid tank 2, the outer faces of the liquid-repellent casing 10 are covered with the outside casing 20, and the outer casing 20 is provided with the gas inlet/outlet port 21. As illustrated in FIG. 4, at least one vertex of the liquid-repellent casing 10 is always in contact with the gas even when the liquid-repellent casing 10 is inclined at any angle. Therefore, the liquid-repellent casing 10 serves as a gas passage, and gas enters/leaves from the vertex 10A which is in contact with the gas, passes through the inside of the liquid-repellent material 11, and goes in/out through the gas inlet/outlet port 21. Therefore, the inner pressure of the liquid-repellent casing 10 is maintained constant.

When a strong vibration, impact, or the like is applied to the liquid A1 on the inside (that is, when large acceleration is applied) due to shaking, dropping, or the like of the liquid tank 2, a large force is applied to the surface of the liquid-repellent material 11 (the force is proportional to the acceleration). When the force exceeds the capillary force, the liquid A1 enters the liquid-repellent material 11 and further reaches the back side of the liquid-repellent material 11. Since the outer faces of the liquid-repellent casing 10 are covered with the outside casing 20 in the embodiment, leakage of the liquid A1 to the outside of the liquid tank 2 is suppressed. While the liquid A1 is contained in the liquid-repellent material 11, the passage of the gas A2 is blocked, so that the function of maintaining the inner pressure constant is lost. However, when the passage of the gas A2 is assured again by movement, vaporization, or the like of the liquid A1, the function of maintaining the inner pressure constant is also recovered.

As described above, in the second embodiment, the outer faces of the liquid-repellent casing 10 are covered with the outside casing 20, and the gas inlet/outlet port 21 is provided for the outside casing 20. Thus, in addition to the effects of the first embodiment, the impact resistance is improved, and the vaporization rate of the liquid A1 is also reduced.

Although the case where each of the liquid-repellent casing 10 and the outside casing 20 has a rectangular parallelepiped shape has been described above in the foregoing embodiment, obviously, the shape of the liquid-repellent casing 10 and the outside casing 20 is not limited.

### Third Embodiment

FIG. 6 illustrates a sectional configuration of a liquid tank according to a third embodiment of the invention. In the embodiment, by properly controlling the shape of a void in the liquid-repellent material 11, the liquid A1 entering the inside of the liquid-repellent material 11 is made autonomously ejected. Except for this, a liquid tank 3 of the embodiment is constructed in a manner similar to the liquid tank 2 described in the second embodiment. Therefore, the same reference numerals are designated to corresponding components.

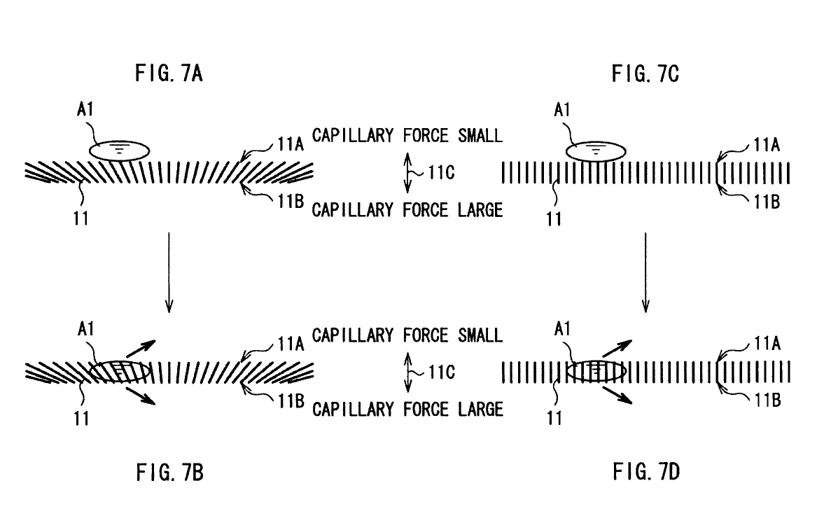

Concretely, in the liquid-repellent material 11 of the embodiment, as illustrated in FIG. 7A, the shape of a void varies in opposing directions 11C (face perpendicular directions) of a surface 11A and a back face 11B. Consequently, the capillary force in the surface 11A is smaller than that in the back face 11B. That is, the capillary force of the liquid-repellent material 11 inclines in the face perpendicular directions.

In this case, as illustrated in FIG. 7B, when the liquid A1 enters the liquid-repellent material 11, the liquid A1 is autonomously ejected to the surface 11A side on which the capillary force is small.

On the other hand, as illustrated in FIG. 7C, in the case where the shape of the void in the liquid-repellent material 11 is uniform in the face perpendicular direction, the capillary force of the liquid-repellent material 11 is also uniform in the face perpendicular direction. In this case, as illustrated in FIG. 7D, when the liquid A1 enters the liquid-repellent material 11, the side from which the liquid A1 is ejected, which is either the surface 11A side or the back face 11B side, is not known. There is also the possibility that the liquid A1 is balanced and remains on the inside.

In the liquid-repellent casing 10 illustrated in FIG. 6, all of the faces are formed of the liquid-repellent material 11 whose capillary force varies in the face perpendicular direction. The surface 11A having smaller capillary force in the liquid-repellent material 11 is disposed on the inner face of the liquid-repellent casing 10. The back face 11B having larger capillary force is disposed on the outer face of the liquid-repellent casing 10. With the arrangement, the liquid A1 entering the inside of the liquid-repellent material 11 is autonomously guided to the surface 11A side on which the capillary force is small and returns to the inside of the liquid-repellent casing 10. Therefore, also in the case where the gas passage is temporarily blocked by an impact or the like, the function of maintaining the inner pressure constant is recovered more easily.

The liquid tank 3 is manufactured in a manner similar to the liquid tank 2 of the second embodiment except that the liquid-repellent material 11 in which the capillary force varies in the face perpendicular direction is formed by properly controlling the shape of a void in a process of manufacturing the liquid-repellent material 11.

In the embodiment as described above, all of the faces of the liquid-repellent casing 10 are made of the liquid-repellent material 11 in which the capillary force is inclined in the face perpendicular direction, the surface 11A having smaller capillary force is disposed on the inner face of the liquid-repellent casing 10, and the back face 11B having larger capillary force is disposed on the outer face of the liquid-repellent casing 10. Consequently, the liquid A1 entering the inside of the liquid-repellent material 11 is autonomously ejected.

### Fourth Embodiment

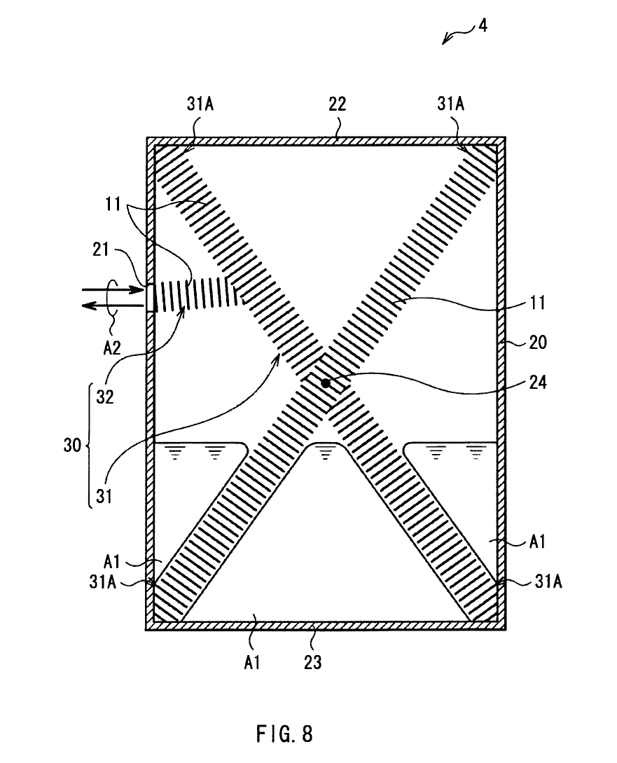

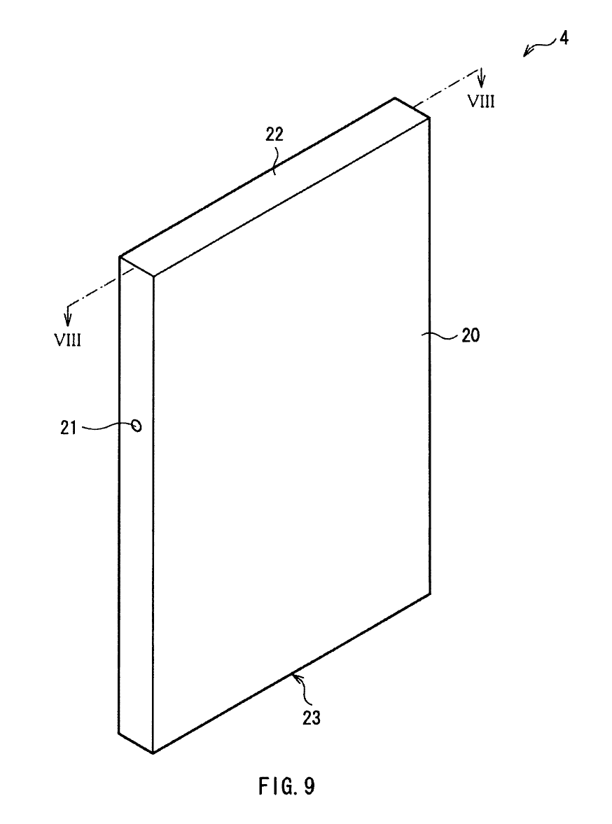

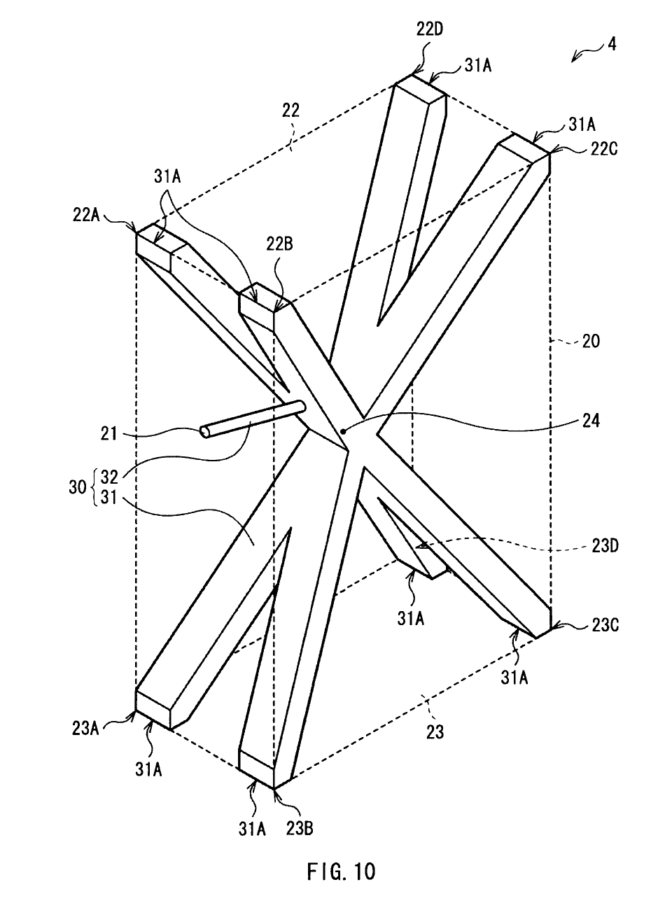

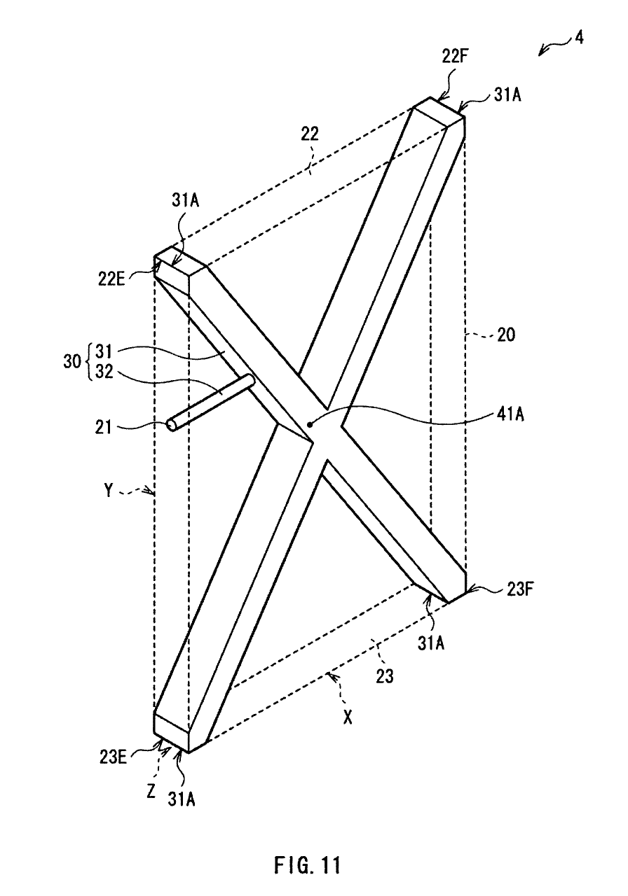

FIG. 8 illustrates a sectional configuration of a liquid tank according to a fourth embodiment of the invention. FIG. 9 expresses the appearance of the liquid tank illustrated in FIG. 8. A liquid tank 4 is constructed in a manner similar to the liquid tank 2 described in the second embodiment except that an X-shaped liquid-repellent structure 30 is provided in place of the liquid-repellent casing 10 in the outside casing 20. Therefore, the same reference numerals are designated to corresponding components.

The outside casing 20 is constructed in a manner similar to the second embodiment.

The liquid-repellent structure 30 has the function as a passage of gas in the outside casing 20, is made of the liquid-repellent material 11 similar to that of the first embodiment, and connects two or more vertexes, sides, or faces of the outside casing 20 and the gas inlet/outlet port 21. With the arrangement, in the liquid tank 3, the inner pressure is maintained constant even in a state where the outside casing 20 is inclined at any angle.

Concretely, the liquid-repellent structure 30 has a liquid-repellent branch 31 which is, for example, an X-shaped branch from a specific position 24 in the outside casing 20. With the configuration, as compared with the case of forming all of the faces of the casing 10 of the liquid-repellent structure 30 of the liquid-repellent material 11 like in the first embodiment, the volume of the liquid-repellent structure 30 is much smaller. As the inside of the liquid-repellent material 11 is filled with gas, by reducing the volume of the liquid-repellent structure 30, the substantial capacity of the liquid tank 4 may be increased.

The liquid-repellent branch 31 has a plurality of ends 31A. In the case where the outside casing 20 has a rectangular parallelepiped shape, as illustrated in FIG. 8, the plurality of ends 31A of the liquid-repellent branch 31 are desirably in contact with eight vertexes of the outside casing 20, that is, all of vertexes 22A to 22D of a top face 22 and all of vertexes 23A to 23D of a bottom face 23. In particular, in the case where the outside casing 20 has a flat rectangular parallelepiped shape, that is, a rectangular parallelepiped shape in which four sides “z” in the thickness direction are shorter than four sides “x” in the width direction and four sides “y” in the height direction, as illustrated in FIG. 9, the plurality of ends 31A of the liquid-repellent branch 31 are preferably in contact with the four sides “z” in the thickness direction of the outside casing 20. With the configuration, azimuth dependence is eliminated, and the invention copes with all of angles in the true sense of the term, that is, all of roll angles (rotation angles of an anterior-posterior axis), pitch angles (rotation angles of the lateral axis), and yaw angles (rotation angles of the vertical axis). The four sides “z” in the thickness direction are two opposed sides 22E and 22F of the top face 22, and two opposed sides 23E and 23F of the bottom face 23.

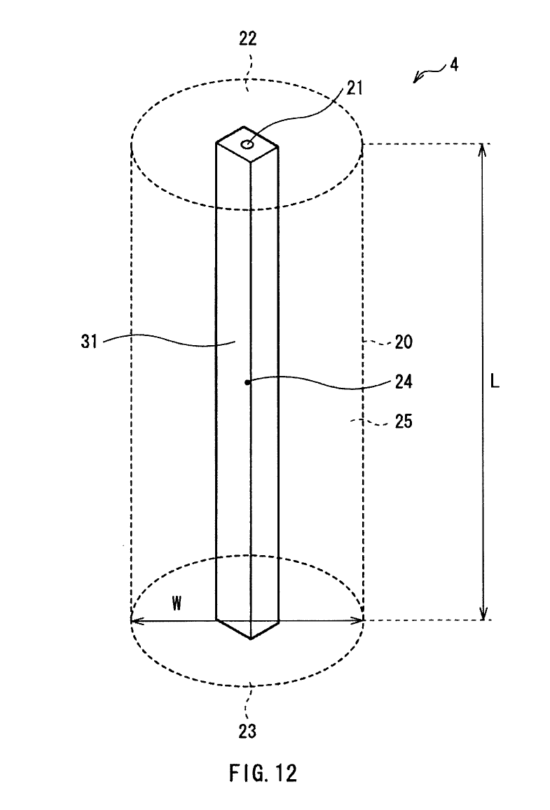

The outside casing 20 may have, for example, a cylindrical shape as illustrated in FIG. 12, that is, a shape having the top face 22 and the bottom face 23 as two opposed end faces and a side face 25 existing between the top face 22 and the bottom face 23. Each of the top face 22 and the bottom face 23 is not limited to a circular shape but may be a shape including a curve such as an ellipse shape or a polygonal shape. The dimension L in the longitudinal direction of the side face 25 is sufficiently longer than the diameter or the greatest dimension W of the top face 22 and the bottom face 23.

In the case where the outside casing 20 has such a cylindrical shape, the plurality of ends 31A of the liquid-repellent branch 31 may be in contact with at least one point in the top face 22 and at least one point in the bottom face 23 for the reason that the azimuth dependence may be eliminated. The ends 31A of the liquid-repellent branch 31 are preferably in contact with the center of the top face 22 and the center of the bottom face 23. Also in this case, in a manner similar to the case of the outside casing 20 having a rectangular parallelepiped shape, the liquid-repellent branch 31 may have a structure of an eight-way branch or a four-way branch.

The specific position 24 as a start point of the liquid-repellent branch 31 is preferably a center position of the outside casing 20. The reason is that the liquid-repellent branch 31 has equivalent distances in all of the directions and it is advantageous to solve the azimuth dependence.

The position of the gas inlet/outlet port 21 is selected in accordance with the configuration of a device side to which the liquid tank 2 is attached and is not limited. Concretely, the gas inlet/outlet port 21 is provided preferably on an extension line of the liquid-repellent branch 31, that is, at the end 31A so that the volume of the liquid-repellent structure 30 is minimized and an extra volume loss is reduced. In the case where the gas inlet/outlet port 21 is provided in a position other than the end 31A of the liquid-repellent branch 31, it is preferable to provide a liquid-repellent connection part 32 connecting the liquid-repellent branch 31 and the gas inlet/outlet port 21.

In a manner similar to the second embodiment, one gas inlet/outlet port 21 is sufficient. Unlike a usual casing, it is unnecessary to provide air holes at the corners of the outside casing 20. Through one gas inlet/outlet port 21, gas is allowed to go out/in. Therefore, even in the case of storing the liquid A1 containing a harmful substance, management of the gas exhausted from the gas inlet/outlet port 21 is facilitated, the possibility that the harmful substance is leaked to the atmosphere is reduced, and safety improved.

The liquid tank 4 may be manufactured, for example, as follows.

First, in a manner similar to the first embodiment, the liquid-repellent material 11 is formed, and the liquid-repellent structure 30 having the liquid-repellent branch 31 and, as necessary, the liquid-repellent connection part 32 is formed. Next, the outside casing 20 having the gas inlet/outlet port 21 is formed of the above-described material, and the liquid-repellent structure 30 is disposed in the outside casing 20. In such a manner, the liquid tank 4 is completed.

In the liquid tank 4, two or more vertexes, sides, or faces of the outside casing 20 and the gas inlet/outlet port 21 are connected via the liquid-repellent structure 30. Since the liquid-repellent structure 30 is made of the liquid-repellent material 11 having voids through which gas passes, liquid does not enter due to the capillary force, and the inside is always willed with gas. As illustrated in FIG. 4, at least one vertex of the outside casing 20 is always in contact with the gas even when the outside casing 20 is inclined at any angle. Therefore, gas enters/leaves from a vertex which is in contact with the gas, a side including the vertex, or a part of a face including the vertex, passes through the inside of the liquid-repellent structure 30, and goes in/out through the gas inlet/outlet port 21, and the inner pressure is maintained constant. Since the outer faces of the liquid-repellent casing 10 are covered with the outside casing 20, even in the case where a strong vibration, impact, or the like is applied to the liquid A1 on the inside, leakage of the liquid A1 to the outside of the liquid tank 4 is suppressed.

In the embodiment as described above, the liquid-repellent structure 30 is made of the liquid-repellent material 11 having voids through which gas passes, and two or more vertexes, sides, or faces of the outside casing 20 and the gas inlet/outlet port 21 are connected via the liquid-repellent structure 30. Therefore, even in a state where the outside casing 20 is inclined at any angle, the inner pressure is maintained constant.

### Fifth Embodiment

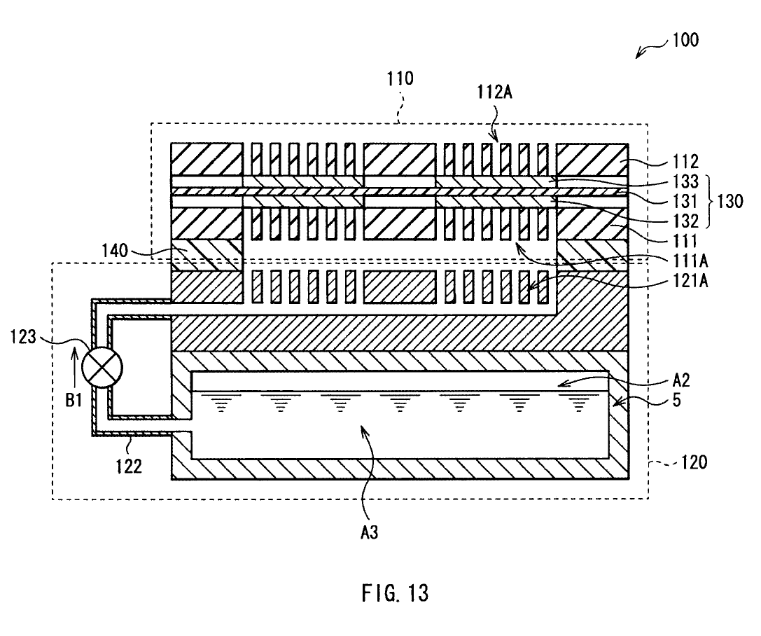

FIG. 13 illustrates a sectional configuration of a fuel cell according to a fifth embodiment of the invention. A fuel cell 100 is a direct methanol fuel cell (DMFC) to which a liquid fuel, for example, methanol is directly supplied to make a reaction. The fuel cell 100 is used for an electric device such as a cellular phone or a notebook-sized personal computer. The fuel cell 100 has, for example, a fuel cell body 110 and a fuel cartridge 120.

The fuel cell body 110 has a plurality of joined members 130. Each of the joined members 130 has a configuration that an anode electrode (fuel electrode) 132 and a cathode electrode (oxygen electrode) 133 are disposed so as to face each other while sandwiching an electrolyte film 131. The joined member 130 is sandwiched between an anode-side plate member 111 and a cathode-side plate member 112 and sealed by, for example, a gasket (not shown). Although the electrolyte film 131 is a layer common to the plurality of joined members 130 in FIG. 13, it may be provided for each of the joined members 130.

The electrolyte film 131 is made of, for example, a proton conducting material having a sulfonate group (—SO3H). Examples of the proton conducting material include a polyperfluoroalkylsulfonic-acid-based proton conducting material (for example, “Nafion (registered trademark)” manufactured by Du Pont Kabushiki Kaisha), a hydrocarbon-based proton conducting material such as polyimide sulfonic acid, and a fullerene-based proton conducting material.

The anode electrode 132 and the cathode electrode 133 have a configuration that, for example, a catalyst layer containing catalyst such as platinum (Pt) or ruthenium (Ru) is formed in a gas diffusion base material such as carbon paper. The catalyst layer is constructed by dispersing a support material such as carbon black supported catalyst into a polyperfluoroalkylsulfonic-acid-based proton conducting material or the like. To the anode electrode 132, a liquid fuel containing methanol is supplied as a gas via an opening 111A formed in the anode-side plate member 111. The cathode electrode 133 is communicated with the outside via an opening 112A formed in the cathode-side plate member 112. Air, that is, oxygen is supplied to the cathode electrode 133 by natural ventilation or an air supply pump (not illustrated).

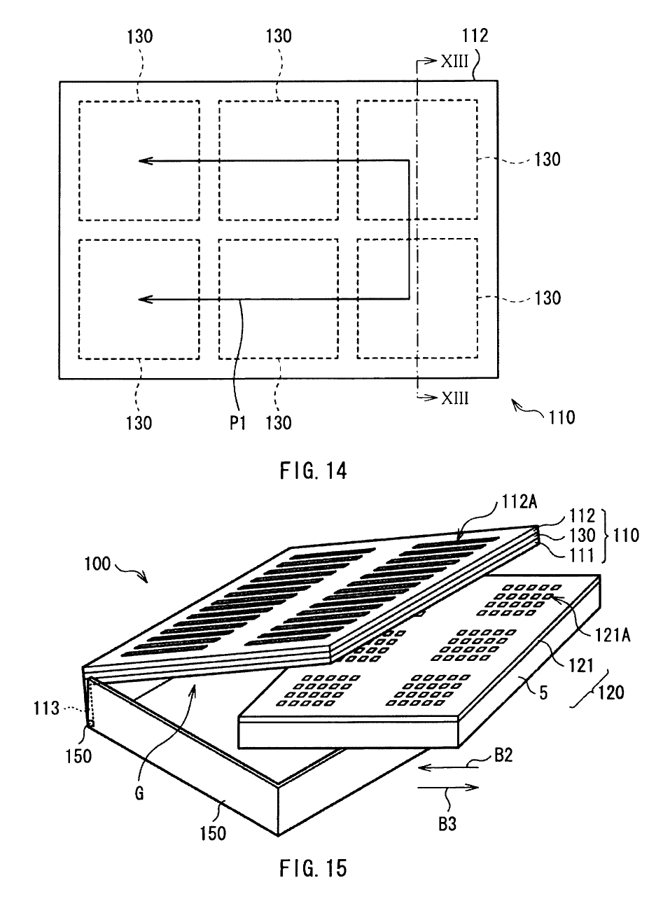

FIG. 14 is a plan configuration of the fuel cell body 110 illustrated in FIG. 13 when viewed from the cathode-side plate member 112. For example, total six joined members 130 are disposed in an arrangement of three joined members 130 by two joined members 130 in the plane direction. For example, the six joined members 130 are electrically connected in series as shown by a reference numeral P1 by a not-shown power collecting structure.

The fuel cartridge 120 illustrated in FIG. 13 is provided on the side of the anode-side plate member 111 of the fuel cell body 110 and has a fuel tank 5 which will be described later and a vaporization unit 121. The fuel tank 5 and the vaporization unit 121 are connected to each other via a flow path 122. The flow path 122 is provided with a pump 123. A liquid fuel A3 from the fuel tank 5 is transported to the vaporization unit 121 in one direction B1 by a pump 123.

The vaporization unit 121 makes the liquid fuel A3 supplied from the fuel tank 5 vaporize and eliminates impurities (such as ionic impurity and a plasticizer having large molecular weight) of low vapor pressure contained in the fuel on the basis of the theory of distillation. The vaporization unit 121 is obtained by providing a diffuser (not shown) for promoting diffusion of the fuel on a plate-shaped member (not shown) having, for example, a thickness of about 0.1 mm to 1.0 mm and made of a metal or alloy containing stainless steel, aluminum, or the like or a resin material having high rigidity such as cycloolefin copolymer (COC). For the diffuser, an inorganic porous material or resin porous material such as alumina, silica, titanium oxide, or the like may be used. Preferably, the vaporization unit 121 has an inner flow path by stacking plate-shaped members made of stainless steel. With the configuration, efficient fuel supply is enabled, so that it is advantageous to reduce thickness. In the surface of the vaporization unit 121, a nozzle 121A as a fuel exhaust port is formed. The nozzle 121A has a diameter of, for example, 0.1 mm to 0.5 mm.

A sealing layer 140 is provided between the fuel cell body 110 and the vaporization unit 121. The sealing layer 140 is provided around the fuel cell body 110 and is made of a resin material such as silicon rubber, ethylene-propylene-diene rubber, Teflon (registered trademark), or the like. With the configuration, a predetermined space S is provided between the fuel cell body 110 and the vaporization unit 121. By the space S, the fuel ejected from the vaporization unit 121 is further diffused, so that the fuel is supplied uniformly to the fuel cell body 110.

Preferably, the fuel cartridge 120 is detachable from the fuel cell body 110, for example, as illustrated in FIG. 15. The impurity contained in the fuel is condensed in the vaporization unit 121 and, by use of long time, makes the fuel supply function deteriorate. By making the fuel cartridge 120 detachable, the vaporization unit 121 is replaced at the time of replacing the fuel cartridge 120 to periodically eliminate evaporation residue of the impurity condensed in the vaporization unit 121.

Concretely, below the fuel cell body 110, a housing member 150 in which a top face and one of four side faces are open is disposed. The fuel cell body 110 covers the top face of the housing member 150. One of the anode-side plate member 111 and the cathode-side plate member 112 is provided with a projection 113 corresponding to the opened side face of the housing member 150. The projection 113 is rotatably coupled to the housing member 150 by a hinge 151 so that the fuel cell body 110 opens/closes the housing member 150. The fuel cartridge 120 is housed from a gap G between the housing member 150 and the anode-side plate member 112 to the inside of the housing member 150 in an arrow B2 direction, or is taken out in an arrow B3 direction which is opposite to the arrow B2 direction. A not-shown housing unit such as a control circuit is provided at the inner bottom of the housing member 150.

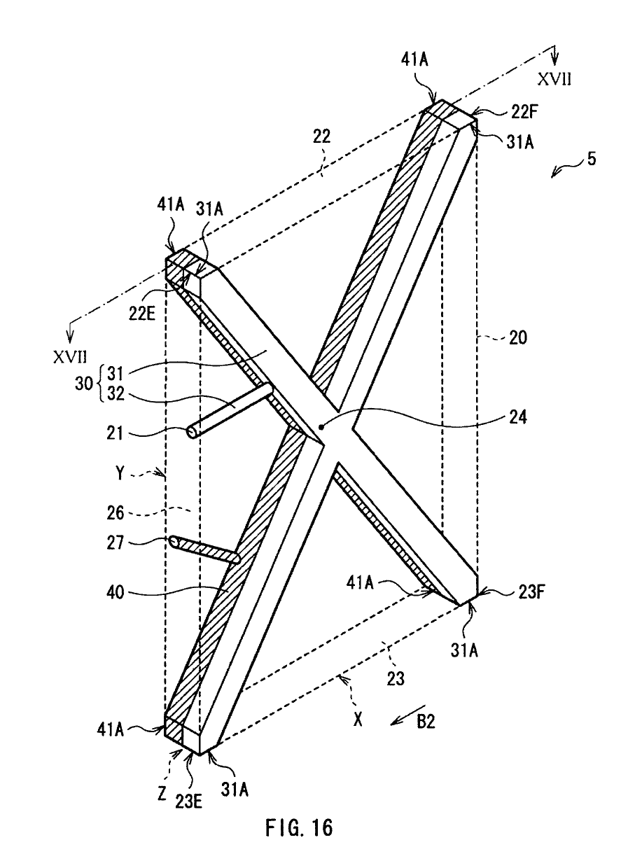

FIG. 16 illustrates the configuration in the outside casing 20 of the fuel tank 5 shown in FIG. 13. In the outside casing 20, the gas inlet/outlet port 21 and a liquid inlet/outlet port 27 are formed in a front end face 26 in the housing direction B2 to the housing member 150. On the inside of the outside casing 20, the liquid-repellent structure 30 and a lyophile structure 40 are provided.

The outside casing 20 is constructed in a manner similar to the second and third embodiments. The position, the number of pieces, and the like of the liquid inlet/outlet port 27 are not limited but are selected according to the configuration on a device side to which the liquid tank 2 is attached. The liquid inlet/outlet port 27 does not always have to be provided on the same face as that of the gas inlet/outlet port 21.

The liquid-repellent structure 30 is constructed in a manner similar to that of the third embodiment.

The lyophile structure 40 serves as a passage of the liquid fuel A3 in the outside casing 20 and connects two or more vertexes, sides, or faces of the outside casing 20 and the liquid inlet/outlet port 27. The lyophile structure 40 has, for example, the same shape as that of the liquid-repellent structure 30 and is disposed so as to be overlapped on the liquid-repellent structure 30 in the outside casing 20.

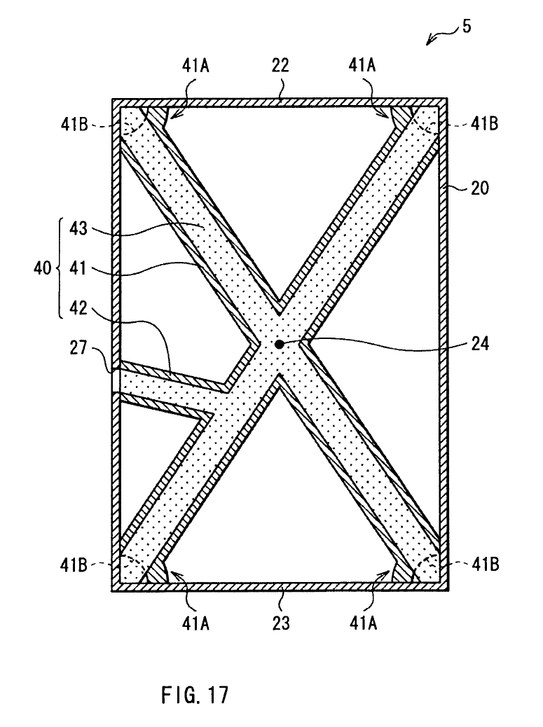

FIG. 17 illustrates a sectional structure of the lyophile structure 40. The lyophile structure 40 has, for example, branch pipes 41 branched from the specific position 24 in the outside casing 20 into an X shape, and a lyophile internal member 43 provided on the inside of the branch pipes 41. In the case where the liquid inlet/outlet port 27 is provided in a position other than ends 41A of the branch pipes 41, the branches 41 and the liquid inlet/outlet port 27 are connected via a connection pipe 42. The lyophile internal member 43 is provided also in the connection pipe 42.

The branch pipe 41 has a plurality of ends 41A. The plurality of ends 41A are in contact with two or more vertexes, sides, or faces of the outside casing 20. Each of the plurality of ends 41A is provided with a liquid inlet 41B. With the configuration, in the liquid tank 4, all of the liquid fuel A3 in the outside casing 20 is taken out even in a state where the outside casing 20 is tilted at any angle.

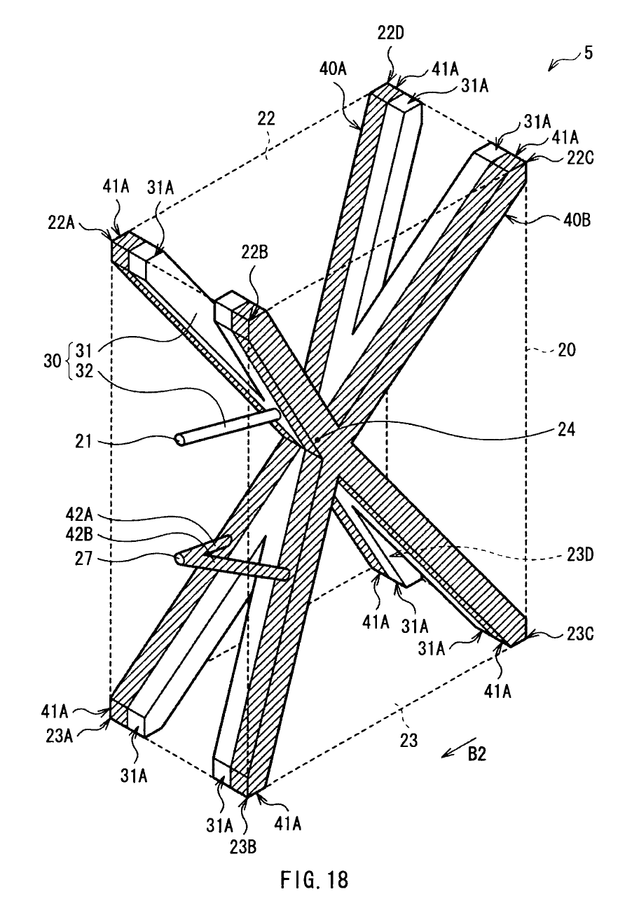

Concretely, in the case where the outside casing 20 has a rectangular parallelepiped shape, as illustrated in FIG. 18, the plurality of ends 41A of the branch pipes 41 are desirably in contact with eight vertexes of the outside casing 20, that is, all of the vertexes 22A to 22D of a top face 22 and all of the vertexes 23A to 23D of the bottom face 23. In particular, in the case where the outside casing 20 has a flat rectangular parallelepiped shape, that is, a rectangular parallelepiped shape in which four sides “z” in the thickness direction are shorter than four sides “x” in the width direction and four sides “y” in the height direction, as illustrated in FIG. 16, the plurality of ends 41A of the branch pipes 41 are preferably in contact with the four sides “z” in the thickness direction of the outside casing 20. With the configuration, azimuth dependence is eliminated, and the invention copes with all of angles in the true sense of the term, that is, all of roll angles (rotation angles of an anterior-posterior axis), pitch angles (rotation angles of the lateral axis), and yaw angles (rotation angles of the vertical axis).

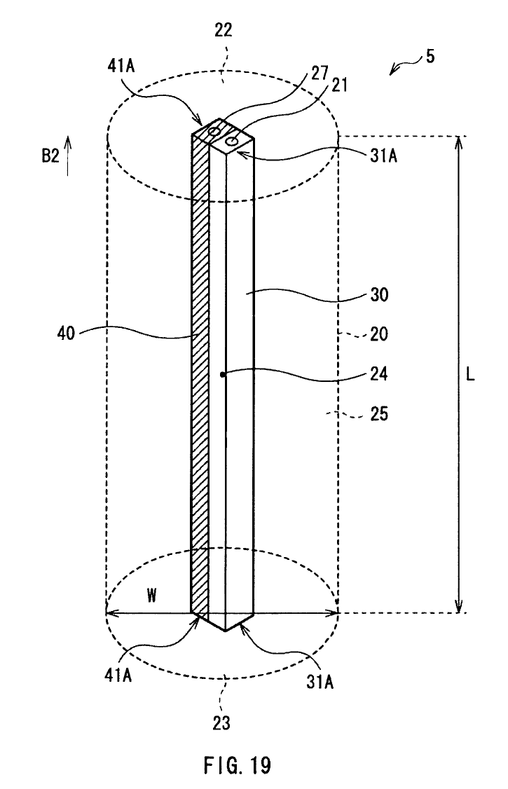

In the case where the outside casing 20 has a cylindrical shape, as illustrated in FIG. 19, the plurality of ends 41A of the branch pipe 41 may be in contact with at least one point in the top face 22 and at least one point in the bottom face 23 for the reason that the azimuth dependence may be eliminated. The ends 41A of the branch pipe 41 are preferably in contact with the center of the top face 22 and the center of the bottom face 23. Also in this case, in a manner similar to the case of the outside casing 20 having a rectangular parallelepiped shape, the branch pipe 41 may have a structure of an eight-way branch or a four-way branch.

In the case where the plurality of ends 41A of the branch pipe 41 are in contact with eight vertexes of the outside casing 20 as illustrated in FIG. 18, the lyophile structure 40 may be divided into two lyophile structures and the two lyophile structures may be disposed on both sides of the liquid-repellent structure 30. The ends 41A of a lyophile structure 40A as one of lyophile structures are in contact with the vertexes 22A and 22D of the top face 22 and the vertexes 23A and 23D of the bottom face 23. The ends 41A of the other lyophile structure 40B are in contact with the vertexes 22B and 22C of the top face 22 and the vertexes 23B and 23C of the bottom face 23. The two lyophile structures 40A and 40B are communicated with each other via connection pipes 42A and 42B and are connected to the liquid inlet/outlet port 27.

Similarly, also in the case where the plurality of ends 41A of the branch pipe 41 are in contact with the four sides “z” in the thickness direction of the outside casing 20 as illustrated in FIG. 16, the lyophile structure 40 may be divided into two lyophile structures, and the two lyophile structures may be disposed on both sides of the liquid-repellent structure 30. In this case as well, the ends 41A of a lyophile structure 40A as one of lyophile structures are in contact with the vertexes 22A and 22D of the top face 22 and the vertexes 23A and 23D of the bottom face 23. The ends 41A of the other lyophile structure 40B are in contact with the vertexes 22B and 22C of the top face 22 and the vertexes 23B and 23C of the bottom face 23. The two lyophile structures 40A and 40B are communicated with each other via the connection pipes 42A and 42B and are connected to the liquid inlet/outlet port 27.

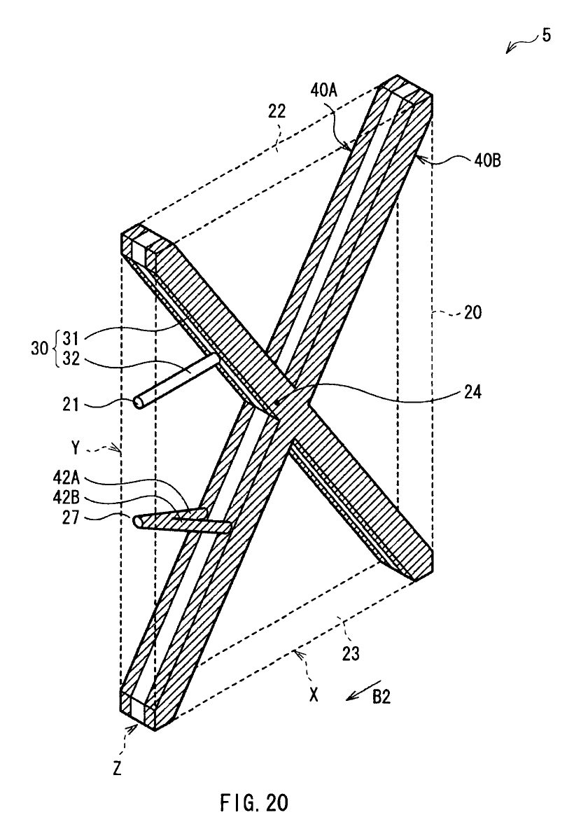

In FIGS. 18 and 20, the liquid-repellent structure 30 may be divided into two structures and the two structures may be disposed on both sides of the lyophile structure 40. However, it is more preferable to divide the lyophile structure 40 into two structures and dispose the two structures on both sides of the liquid-repellent structure 30. In the liquid tank 4, it is important to use the liquid fuel A3 all. Since the remaining liquid fuel A3 tends to accumulate at the vertexes of the outside casing 20, by disposing the lyophile structure 40 at the eight vertexes of the outside casing 20, the liquid fuel A3 is taken out more easily.

In the case where the branch pipe 41 is constructed by a single pipe and the specific position 24 is the center position of the outside casing 20, the radius “r” of the branch pipe 41 satisfies Formula 1.

SQR(x²+y²+z²)<4γ cos θ/rρg

H1=2γ cos θ/rρg

H2=SQR(x²+y²+z²)/2 Formula 1

(in the equation, SQR(a) denotes the square root of a, x, y, and z denote lengths (m) of the sides of the outside casing 20, H1 denotes height (m) of liquid level rise by capillary force in the case of a cylindrical pipe, γ denotes surface tension (N/m) of the liquid, θ indicates contact angle, r indicates radius (m) of the pipe, ρ expresses density (kg/m³) of the liquid, g expresses acceleration of gravity (9.8 m/s²), and H2 expresses height (m) of the liquid level rise necessary in the liquid tank 4.)

The second equation in Formula 1 expresses the height H1 of the liquid level rise by the capillary force in the case where the branch tube 41 is a cylindrical tube. The third equation in Formula 1 expresses the height H2 of the liquid level rise necessary in the liquid tank 4. Specifically, to take the liquid fuel A3 to the outside of the outside casing 20 with a needle (not shown) or the like from the specific position 24, the level of the liquid fuel A3 has to be risen by the capillary force from the liquid inlet 41B at least to the specific position 24. Therefore, in the case where the outside casing 20 has a rectangular parallelepiped shape, the height H2 of the liquid level rise necessary in the liquid tank 4 is a distance from each of the vertexes of the outside casing 20 to the specific position 24, that is, the center position of the outside casing 20. Consequently, under condition of satisfying H2<H1, that is, the first equation of Formula 1, the dimension of the outside casing 20, the material of the branch pipe 41, the inside diameter of the branch pipe 41, or the like has to be selected. Obviously, in the case where the specific position 24 is not the center position of the outside casing 20, the third equation of Formula 1 for obtaining the height H2 becomes different.

In the case of constructing the branch pipe 41 by a single pipe, the material and the inside diameter of the branch pipe 41 are obtained by substituting an approximate dimension and a property value in the first equation of Formula 1. For example, when the dimensions x, y, and z of the outside casing 20 are 18 mm, 34 mm, and 5.5 mm, respectively, as property values, 21 N/m is substituted for γ, 30° is substituted for θ, and 0.79 g/cm3 is substituted for ρ, it is understood that the radius “r” of the branch pipe 41 has to be set to 242 μm or less. That is, it is understood that the branch pipe 41 is made of a material having high wettability and having a contact angle of about 30 degrees, and the inside diameter has to be less than 484 μm.

However, the inside diameter of 484 μm is a very small value. When the liquid fuel A3 is taken forcibly, the flow path resistance is high, and considerable suction pressure is required. To solve the problem, for example, it is considered to construct the branch pipe 41 by a bundle of tubules each having the inside diameter of 484 μm or a porous member, a sponge material, a foam material, or a fiber material having an average pore diameter of 484 μm (hereinbelow, called “foam material or the like”). Strictly, the inside diameter of the pipe is not replaced with the average pore diameter of the foam material or the like, but it is considered that there is no problem in argument of approximate figures. There is another largely different point between the pipe and the foam material or the like. Specifically, in the pipe, the liquid enters and leaves only at both end faces. On the other hand, the liquid enters/leaves at any faces of the foam material or the like, so that the direction of flow is not determined. Since the foam material or the like is used as a replacement of the pipe, it is important to cover the side face of the foam material or the like so that the liquid fuel A3 enters/leaves only at both end faces like the pipe, that is, to fill the branch pipe 41 with the foam material or the like. By covering the foam material or the like by the branch pipe 41, an advantage that evaporation of the liquid fuel A3 is suppressed is also obtained.

The lyophile internal member 43 corresponds to the foam material or the like as a substitution of the pipe, is formed by a lyophile material which is made of at least one of a porous material, a sponge material, a foam material, a fiber material, and a tubule bundle, and has a number of voids for passing a liquid. The voids in the lyophile internal member 43 have an average pore diameter with which the liquid fuel A3 is taken from the inlet 41B to the specific position 24 by the capillary force. Concretely, the average pore diameter of the lyophile internal member 43 satisfies requirements similar to Formula 1 related to the radius “r” in the case where the branch pipe 41 is constructed by a single pipe. In the liquid tank 4, therefore, the diameter of the branch pipe 41 is increased, increase in the flow path resistance is suppressed, intake speed or intake amount of the liquid fuel A3 is increased, and the suction pressure of the liquid fuel A3 is lowered. The lyophile internal member 43 may be made of at least one of a porous material, a sponge material, a foam material, a fiber material, and a tubule bundle, or a combination of two or more of the materials.

The lyophile internal member 43 is made of a material having high wettability to the liquid fuel A3, that is, cosine of the contact angle θ of the liquid fuel A3 is positive. From the first equation of Formula 1, to make the radius “r” of the tube a positive value, the cosine of the contact angle θ has to be positive (when θ>90, cos θ<0), so that the average pore diameter of the lyophile internal member 43 also has to satisfy a requirement similar to that for the radius “r” of the pipe. From the first equation of Formula 1, it is understood that, to increase the dimension of the outside casing 20, the smaller the pore diameter of the lyophile internal member 43 is, the better and, the higher the wettability is, the better.

For example, a suitable material of the lyophile internal member 43 is natural fiber, animal hair fiber, polyacetal, acrylic resin, polyester resin such as polyethylene terephthalate, polyamide resin such as nylon, polyolefin-based resin such as polyurethane, polypropylene, or polyethylene, polyvinyl, polycarbonate, polyether resin, polyphenylene resin, polylactic resin, foam metal, foam oxide, zeolite, or biscuit-fired pottery. By performing ozone process or the like on the materials, the wettability for methanol may be improved. The lyophile internal member 43 may be made of a foam (foam member), a felt, a felt sintered body, or a particle sintered body made of one of the materials or a combination of two or more of them. A concrete material is, for example, a porous metal material made of nickel (Ni) (such as Celmet (trade name) manufactured by Sumitomo Electric Toyama Co., Ltd.)

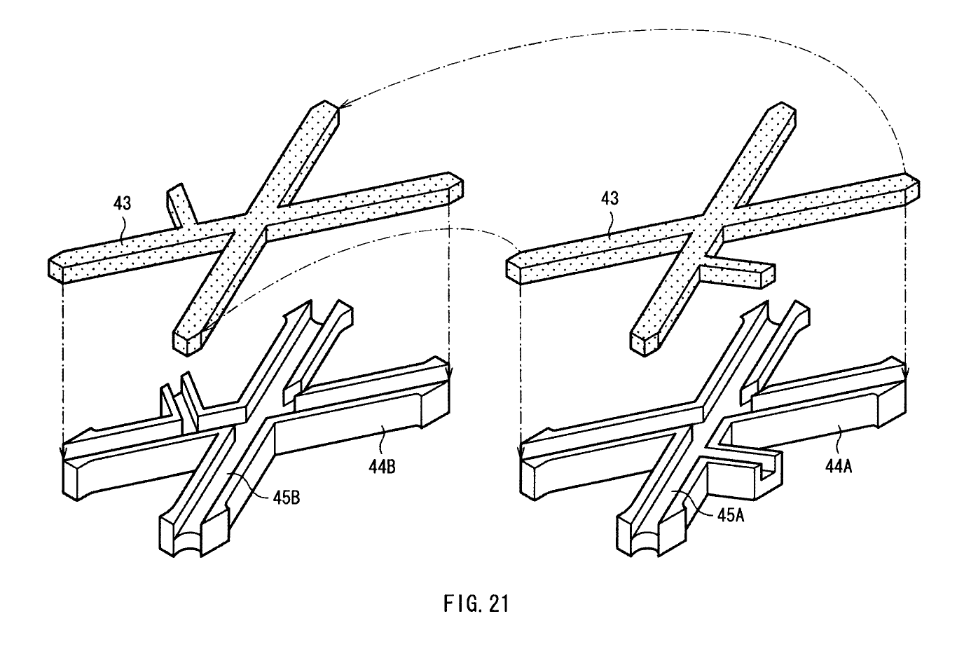

FIG. 21 illustrates an example of a concrete structure of the lyophile structure 40. The branch pipe 41 and the connection pipe 42 have a configuration obtained by, for example, overlapping a pair of X-shaped halved members 44A and 44B made of stainless steel (such as SUS304) and adhering them by an adhesive (not shown). Grooves 45A and 45B are formed in the halved members 44A and 44B, respectively. By combining the grooves 45A and 45B, the branch pipe 41 and the connection pipe 42 are formed. In the grooves 45A and 45B, the lyophile inner member 43 is housed.

The fuel cell 100 is manufactured, for example, as follows. In the following manufacturing method, the case of forming the lyophile structure 40 by using the halved members 44A and 44B illustrated in FIG. 21 will be described.

First, in a manner similar to the first embodiment, the liquid-repellent material 11 is formed. By the liquid-repellent material 11, the liquid-repellent structure 30 having the liquid-repellent branch 31 and the liquid-repellent connection part 32 is formed.

Next, a thin plate made of the porous metal material is cut along the shape of the grooves 45A and 45B, thereby forming the lyophile internal member 43. The halved members 44A and 44B made of the above-described material are prepared. As illustrated in FIG. 21, the lyophile internal member 43 is filled in the grooves 45A and 45B in the halved members 44A and 44B, respectively. The halved members 44A and 44B are thermal-adhered by an adhesive (not illustrated) of modified polypropylene maleate or the like. By the process, the lyophile structure 40 illustrated in FIG. 17 is formed.

Subsequently, by the above-described material, the outside casing 20 having the gas inlet/outlet port 21 and the liquid inlet/outlet port 27 is formed. In the outside casing 20, the liquid-repellent structure 30 and the lyophile structure 40 are disposed. As a result, the liquid tank 5 illustrated in FIGS. 16 and 17 is completed.

After that, the vaporization unit 121 is disposed in one face of the liquid tank 5, and the liquid tank 5 and the vaporization unit 121 are connected to each other via the flow path 122. The flow path 1122 is provided with the pump 123. As a result, the fuel cartridge 120 illustrated in FIG. 15 is formed.

The electrolyte film 131 made of the above-described material is sandwiched between the anode electrode 132 and the cathode electrode 133 made of the above-described material, and the resultant is thermal-compression-bonded. The anode electrode 132 and the cathode electrode 133 are bonded to the electrolyte film 131, thereby forming the joined member 130. After that, the joined members 130 are electrically connected in series and disposed between the anode-side plate member 111 and the cathode-side plate member 112. By the above operation, the fuel cell body 110 illustrated in FIG. 13 is formed. Finally, the fuel cartridge 120 is disposed on the outside of the anode-side plate member 111 of the fuel cell body 110. As a result, the fuel cell 100 illustrated in FIG. 13 is completed.

In the fuel cell 100, the liquid fuel A3 is supplied from the liquid tank 5 to the anode electrode 132 of each joined member 130, and protons and electrons are generated by a reaction. The protons pass through the electrolyte film 131, move to the cathode electrode 133, and reacts with the electrons and oxygen, thereby creating water. By the operation, the liquid fuel A3, that is, a part of chemical energy of methanol is converted to electric energy and taken as current, and an external load is driven.

In the liquid tank 5, two or more vertexes, sides, or faces of the outside casing 20 and the gas inlet/outlet port 21 are connected via the liquid-repellent structure 30. Since the liquid-repellent structure 30 is made of the liquid-repellent material 11 having voids through which gas passes, liquid fuel A3 does not enter due to the capillary force, and the inside is always willed with gas. As illustrated in FIG. 4, at least one vertex of the outside casing 20 is always in contact with gas in either the top face 22 or the bottom face 23 even when the outside casing 20 is inclined at any angle. Therefore, gas enters/leaves from a vertex which is in contact with the gas, a side including the vertex, or a part of a face including the vertex, passes through the inside of the liquid-repellent structure 30, and goes in/out through the gas inlet/outlet port 21, and the inner pressure is maintained constant. Since the outer faces of the liquid-repellent casing 10 are covered with the outside casing 20, even in the case where a strong vibration, impact, or the like is applied to the liquid A1 on the inside, leakage of the liquid A1 to the outside of the liquid tank 4 is suppressed.

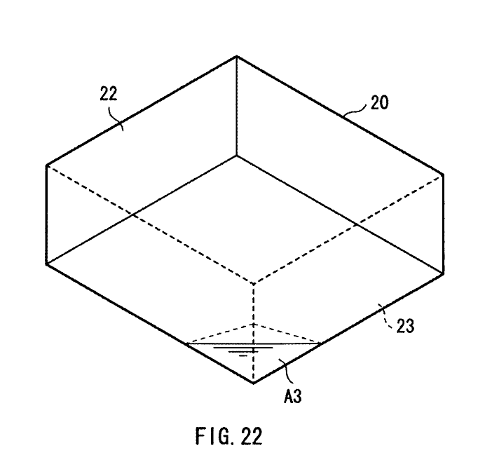

Since the inlet 41B of the liquid fuel A3 to the lyophile structure 40 is regulated only at the end of the branch pipe 41, a predetermined direction is created in the flow of the liquid fuel A3 in the outside casing 20 such that the liquid fuel A3 enters the branch pipe 41 only from the inlet 41B, is transported to the specific position 24, and is sucked via connection pipe 42 to the outside of the outside casing 20 at the liquid inlet/output port 27. As illustrated in FIG. 22, at least one of the vertexes 22A to 22D and 23A to 23D is in contact with the liquid fuel A3 at any tilt angle of the outside casing 20. Therefore, even when the liquid fuel A3 in the outside casing 20 decreases, the liquid fuel A3 existing at any of the four sides “z” in the thickness direction in the outside casing 20 enters the branch pipe 41 from the inlet 41B at the front of the branch pipe 41 which is in contact with the side. Therefore, even when the outside casing 20 is inclined at any angle, all of the liquid fuel A3 is taken out.

Further, the lyophile structure 40 has the lyophile internal member 43 formed by the lyophile material which is made of at least one of a porous material, a sponge material, a foam material, a fiber material, and a tubule bundle. Thus, increase in the flow path resistance in the branch pipe 41 is suppressed, the intake speed or intake amount of the liquid fuel A3 is increased, and the suction pressure of the liquid fuel A3 is lowered.

In the liquid tank 5 of the embodiment as described above, the liquid-repellent structure 30 is made of the liquid-repellent material 11 having voids through which gas passes. By the liquid-repellent structure 30, two or more vertexes, sides, or faces of the outside casing 20 and the gas inlet/outlet port 21 are connected. Therefore, even in a state where the outside casing 20 is inclined at any angle, the inner pressure is maintained constant. Thus, by using the liquid tank 5 for the fuel cartridge 120 of the fuel cell 100, abnormal ejection of the liquid fuel A3 and breakage of the liquid tank 5 is suppressed, so that safety improves.

Since the lyophile structure 40 is provided in the outside casing 20 and the inlet 41B of the liquid fuel A3 is provided at the end of the branch pipe 41, the direction of flow of the liquid fuel A3 becomes constant. Even the amount of the liquid fuel A3 becomes small, the liquid fuel A3 is reliably taken out. Therefore, even when the outside casing 20 is inclined at any angle, all of the liquid fuel A3 in the outside casing 20 is taken out. In particular, the liquid tank 5 is suitable to the fuel cell 100 to be mounted on a portable electronic device, the use efficiency of the liquid fuel A3 is increased, and the user-friendliness of the device improves.

Particularly, since the lyophile internal member 43 formed by the lyophile material which is made of at least one of a porous material, a sponge material, a foam material, a fiber material, and a tubule bundle is provided in the lyophile structure 40, increase in the flow path resistance is suppressed, the intake speed or intake amount of the liquid fuel A3 is increased, and the suction pressure of the liquid fuel A3 is lowered.

### Sixth Embodiment

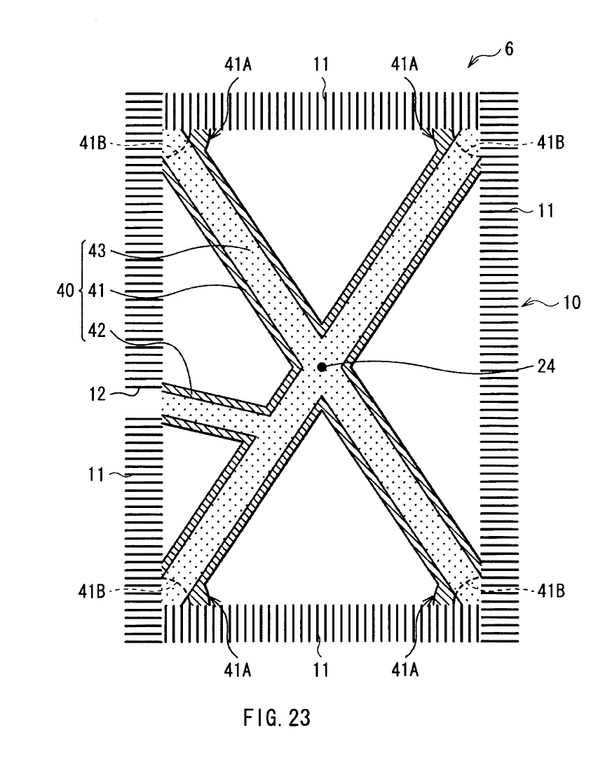

FIG. 23 illustrates a sectional configuration of a fuel tank 6 according to a sixth embodiment of the invention. The fuel tank 6 is obtained by providing the liquid-repellent casing 10 of the fuel tank 1 according to the first embodiment with a liquid inlet/outlet port 12 and providing the lyophile structure 40 similar to that of the fifth embodiment in the liquid-repellent casing 10. The operation and effect of the fuel tank 6 are similar to those of the first and fifth embodiments. The fuel tank 6 may be manufactured in a manner similar to that of the first and fifth embodiments.

### Seventh Embodiment

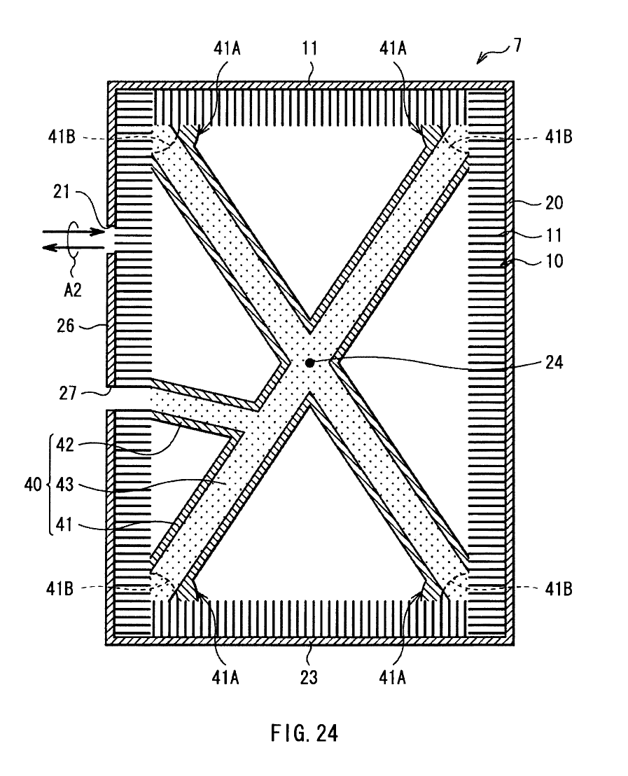

FIG. 24 illustrates a sectional configuration of a fuel tank 7 according to a seventh embodiment of the invention. The fuel tank 7 is obtained by providing the outside casing 20 of the fuel tank 2 according to the second embodiment with the liquid inlet/outlet port 27, providing the liquid-repellent casing 10 with the liquid inlet/outlet port 12, and providing the lyophile structure 40 similar to that of the fifth embodiment in the liquid-repellent casing 10. The operation and effect of the fuel tank 7 are similar to those of the second and fifth embodiments. The fuel tank 7 may be manufactured in a manner similar to that of the second and fifth embodiments.

### Eighth Embodiment

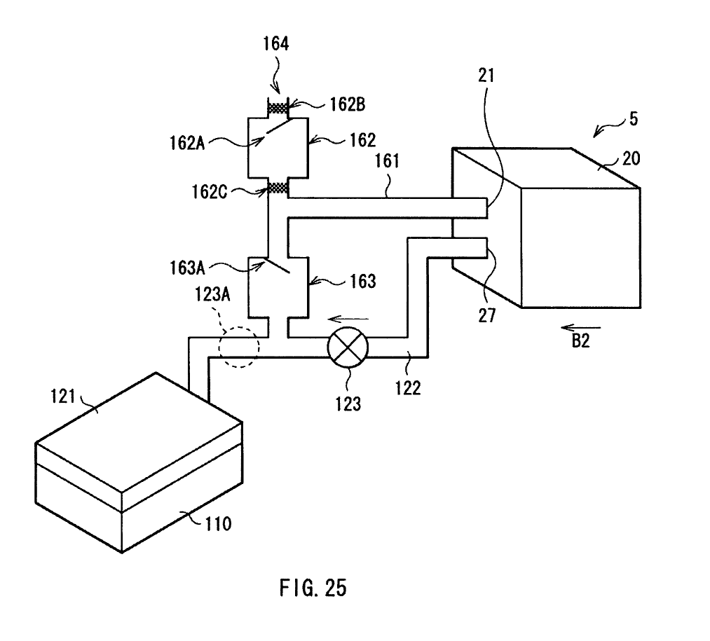

FIG. 25 illustrates the configuration of the fuel cell 100 according to an eighth embodiment of the invention. The fuel cell 100 realizes improved safety, for example, in the liquid tank 5 according to the fifth embodiment, by taking air from the outside air and guiding exhaust to the fuel cell body 110. Therefore, the same reference numerals are designated to corresponding components.

The fuel cell body 110 is constructed in a manner similar to the fifth embodiment.

The fuel cartridge 120 has, for example, a pipe line 161 connected to the gas inlet/outlet port 21 and a first branch 162 and a second branch 163 branched from the pipe line 161.

The first branch 162 connects the pipe line 161 and an intake port 164 of outside air and has, for example, a backflow preventing valve 162A as a mechanism of regulating the flow of gas to one direction into the liquid tank 4. The second branch 163 connects the pipe line 161, the vaporization unit 121, and the fuel cell body 110, and has a backflow preventing valve 163A as a mechanism of regulating the flow of gas to one direction to the outside of the liquid tank 4. The second branch 163 is communicated with the liquid inlet/outlet port 27 of the liquid tank 4. With the configuration, in the fuel cell 100, a liquid fuel A3 contained in exhaust from the liquid tank 4 is not released to the atmosphere, exposure of the user to methanol or the like is suppressed, and safety improves.

The first branch 162 may be provided with a dust filter 162B or an oxygen absorber filter 162C as necessary. The dust filter 162B is used to remove dusts in the air and is provided, for example, between the intake port 164 and the backflow preventing valve 162A. The oxygen absorber filter 162C is provided to suppress deterioration in power generation performance of the fuel cell body 110 due to oxygen in the air and to suppress oxidation degradation of the fuel and the like. The oxygen absorber filter 162C is provided, for example, between the backflow preventing valve 162A and the gas inlet/outlet port 21.

Although the pump 123 is disposed in the anterior stage of the backflow preventing valve 163A in FIG. 25, the pump 123 may be disposed in a position 123A between the backflow preventing valve 163A and the vaporization unit 121 and the fuel cell body 110.

In the fuel cell 100, when the inner pressure of the outside casing 20 decreases, the gas is sucked from the intake port 164 to the first branch 162. The gas is regulated in one direction B4 into the liquid tank 4 by the backflow preventing valve 162A, and is taken into the liquid tank 4 via the pipeline 161 and the gas inlet/outlet port 21. On the other hand, when the inner pressure of the outside casing 20 rises, the gas is exhausted through the inside of the liquid-repellent structure 30 from the gas inlet/outlet port 21 to the pipeline 161 and the second branch 163. The exhausted gas is regulated to one direction to the outside of the liquid tank 4 by the backflow preventing valve 163A, and is supplied together with vaporized fuel from the liquid inlet/outlet port 27 to the vaporization unit 121 and the fuel cell body 110. The liquid fuel A3 contained in the exhausted gas is consumed by the fuel cell body 110. Therefore, the liquid fuel A3 is not released to the atmosphere, and exposure of the user to methanol or the like is suppressed.

In the embodiment as described above, the pipeline 161 connected to the gas inlet/outlet port 21 is branched to the first and second branches 162 and 163. The first branch 162 is provided with the backflow preventing valve 162A that regulates the flow of gas in one direction to the inside of the liquid tank 4. The second branch 163 is provided with the backflow preventing valve 163A that regulates the flow of gas in one direction to the outside of the liquid tank 4. With the configuration, the liquid fuel A3 contained in the exhaust from the liquid tank 4 is prevented from being released to the atmosphere, exposure of the user to methanol or the like is suppressed, and safety is increased.

The seventh embodiment is also applicable to the fuel tanks 2 and 7 each having the configuration that the outer faces of the liquid-repellent casing 10 are covered with the outside casing 20 as described in the second and seventh embodiments.

Although the present invention has been described above by the embodiments, the invention is not limited to the foregoing embodiments but may be variously modified. For example, in the foregoing embodiments, the case where the specific position 24 as the start point of the liquid-repellent branch 31 or the branch pipe 41 is the center position of the outside casing 20 has been described. However, the specific position 24 is not limited to the above, but may be properly selected according to the posture of the outside casing 20. For example, in the case where the outside casing 20 is relatively often disposed so as to face downward (with the top face 22 positioned downward), a position below the center position may be set as the specific position 24.

For example, the material and thickness of each of the components, the power generation conditions of the fuel cell, and the like described in the foregoing embodiments are not limited but may be other materials, other thickness, and other power generation condition. For example, when any of the liquid tanks 1 to 5 is used as a fuel tank, the liquid fuel is not limited to methanol but may be another liquid fuel such as ethanol or dimethyl ether.

Further, the liquid tank of the invention is applicable not only to a fuel cell but also to fuel tanks of devices (such as an illumination torch, a heater, and an engine) using fuels for burning such as heating oil, light oil, and gasoline), an ink cartridge in an ink-jet printer, a spray gun, a perfume bottle, and the like.

The fuel cell of the invention is suitably used for portable electronic devices such as a cellular phone, an electronic camera, an electronic diary, a notebook-sized personal computer, a camcorder, a portable game machine, a portable video player, a headphone stereo, and PDA (Personal Digital Assistants).

The present application contains subject matter related to that disclosed in Japanese Priority Patent Application JP 2009-085736 filed in the Japan Patent Office on Mar. 31, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid tank comprising:
an outside casing provided with one gas inlet/outlet port; and
a liquid-repellent structure provided on the inside of the outside casing, connecting two or more vertexes, sides, or faces of the outside casing and the gas inlet/outlet port, and made of a liquid-repellent material having a void through which gas passes.

2. The liquid tank according to claim 1, wherein the liquid-repellent structure has liquid-repellent branches branched from a specific position in the outside casing, and a plurality of ends of the liquid-repellent branches are in contact with the two or more vertexes, sides, or faces of the outside casing.

3. The liquid tank according to claim 2, wherein the outside casing has one liquid inlet/outlet port and has therein a lyophile structure, and
the lyophile structure comprises:
branch pipes branched from a specific position in the outside casing, and having a plurality of ends, the plurality of ends being in contact with two or more vertexes, sides, and faces of the outside casing, and each provided with a liquid inlet; and
a lyophile internal member provided in the branch pipes and made of a lyophile material having a void through which liquid passes.

4. The liquid tank according to claim 3, wherein the lyophile structure has the same shape as that of the liquid-repellent structure, and is overlapped on the liquid-repellent structure in the outside casing.

5. The liquid tank according to any one of claims 2 to 4, wherein the outside casing has a rectangular parallelepiped shape in which four sides in thickness direction are shorter than four sides in width direction and four sides in height direction, and
the plurality of ends of the liquid-repellent branch are in contact with the four sides in the thickness direction of the outside casing.

6. The liquid tank according to claim 5, wherein the plurality of ends of the branch pipe are in contact with the four sides in the thickness direction of the outside casing.

7. The liquid tank according to claim 2, wherein the outside casing has a rectangular parallelepiped shape, and
the plurality of ends of the liquid-repellent branch are in contact with eight vertexes of the outside casing.

8. The liquid tank according to claim 7, wherein the plurality of ends of the branch pipe are in contact with the eight vertexes of the outside casing.

9. The liquid tank according to claim 2, wherein the outside casing has a cylindrical shape having two opposed end faces and a side face existing between the two end faces, and
the plurality of ends of the liquid-repellent branch are in contact with the two end faces of the outside casing.

10. The liquid tank according to claim 9, wherein the plurality of ends of the branch pipe are in contact with the two end faces of the outside casing.

11. A liquid tank comprising a liquid-repellent casing whose all of faces are made of a liquid-repellent material having a void through which gas passes.

12. The liquid tank according to claim 11, further comprising an outside casing covering outer faces of the liquid-repellent casing and having a gas inlet/outlet port.

13. The liquid tank according to claim 12, wherein the liquid-repellent material has opposed surface and back face, the shape of the void varies in the opposing direction of the surface and the back face so that capillary force in the surface is smaller than that in the back face,
the surface of the liquid-repellent material is disposed on an inner face of the liquid-repellent casing, and the back face of the liquid-repellent material is disposed on the outer face of the liquid-repellent casing.

14. A fuel cell comprising
a fuel cell body and
a fuel cartridge having a liquid tank,
wherein the liquid tank includes:
an outside casing provided with one gas inlet/outlet port; and
a liquid-repellent structure provided on the inside of the outside casing, connecting two or more vertexes, sides, or faces of the outside casing and the gas inlet/outlet port, and made of a liquid-repellent material having a void through which gas passes.

15. The fuel cell according to claim 14, wherein the fuel cartridge has a vaporization unit that vaporizes liquid fuel supplied from the liquid tank, and is detachable from the fuel cell body.

16. The full cell according to claim 14, further comprising:
a pipeline connected to the gas inlet/outlet port;
a first branch branched from the pipeline and provided with a mechanism of regulating flow of gas to one direction to the inside of the liquid tank; and
a second branch branched from the pipeline, provided with a mechanism of regulating flow of gas in one direction to the outside of the liquid tank, and communicated with the liquid inlet/outlet port.

17. A fuel cell comprising
a fuel cell body and
a fuel cartridge having a liquid tank,
wherein all of faces of the liquid tank are made of a liquid-repellent material having a void through which gas passes.

18. The fuel cell according to claim 17, wherein the fuel cartridge has a vaporization unit that vaporizes liquid fuel supplied from the liquid tank, and is detachable from the fuel cell body.

19. The fuel cell according to claim 17, further comprises:
a pipeline connected to the gas inlet/outlet port;
a first branch branched from the pipeline and provided with a mechanism of regulating flow of gas to one direction to the inside of the liquid tank; and
a second branch branched from the pipeline, provided with a mechanism of regulating flow of gas in one direction to the outside of the liquid tank, and communicated with the liquid inlet/outlet port.
